(19) United States
(12) Patent Application Publication
(10) Pub. No.: US 2005/0181682 A1
(43) Pub. Date: Aug. 18, 2005

(54) Rotation proof ring terminal

(75) Inventors: Jerry L. Stepp, Spartanburg, SC (US); Curtis A. Grau, Duncan, SC (US); Donald R. Cruitt, Lyman, SC (US)

Correspondence Address: THE WEBB LAW FIRM, P.C., 700 KOPPERS BUILDING, 436 SEVENTH AVENUE, PITTSBURGH, PA, 15219, US

(73) Assignee: WESTINGHOUSE AIR BRAKE TECHNOLOGIES CORPORATION

(21) Appl. No.: 10/778,284

(22) Filed: Feb. 13, 2004

(51) Int. Cl. H01R 4/48

(52) U.S. Cl. 439/860

(57) ABSTRACT

The present invention provides an improved electrical terminal for connecting electrical circuits. The electrical terminal includes a first means having an aperture of a predetermined size formed therein to permit engaging of the first means with a mating surface on an electrical device. It also includes an attachment means engageable with each of the first means and the electrical device for attaching the first means to a mating surface of the electrical device, and at least one anti-rotation locking means engageable with the first means at a predetermined location for preventing rotation of the first means when engaged with a mating surface of the electrical device. A second means is disposed adjacent one end of the first means for receiving at least one electrical wire therein in order to permit establishing electrical conductivity between the second means and at least one electrical wire. Finally the present invention includes a third means disposed on an exterior surface of the second means for securing an insulating sleeve thereto along a periphery of the second means.

### FIELD OF THE INVENTION

The present invention relates generally to electrical terminals adapted to be crimped to a conductor and positioned in engagement with an upstanding stud and, more particularly, this invention relates to ring tongue terminals having a wire crimp ferrule which can be crimped to the stripped ends of an insulated conductor, and even more particularly, this invention relates to an electrical ring terminal used to connect electrical circuits in subway and railway electrical couplers.

### BACKGROUND OF THE INVENTION

Ring tongue type terminals, such as those shown in U.S. Pat. No. 4,605,279, have long been employed to establish an electrical connection between an insulated wire and a free-standing binding post or upstanding stud. Conventional ring tongue terminals provide a simple and economical electrical interconnection. Ring tongue type terminals can be secured to threaded studs and a nut can be secured to the stud to hold the terminal to the stud and to establish a satisfactory electrical interconnection.

Conventional ring tongue terminals are normally crimped to stripped ends of insulated wires. Open barrel or closed barrel crimps can be used, depending upon the requirements of the specific interconnection. Suitable application tooling is conventionally available to permit automated stripping of the conductors and efficient crimping of the terminals to the stripped conductor ends.

Conventional ring tongue terminals are available in a large number of variations including terminals having a pre-insulated wire crimp, terminals having a generally circular stud contact surface, terminals having a square or rectangular tongue, terminals having the hole in the contact tongue in alignment with the axis of the wire barrel, or terminals having the hole in the contact tongue transversely or offset from the axis of the wire crimp ferrule. Prior art publications also disclose ring tongue terminals having internal teeth projecting from the plane of a circular ring tongue along the inner edge of the binding hole used to secure the ring terminal to the threads of a stud. However, there are presently no ring tongue terminals that are rotational proof.

### SUMMARY OF THE INVENTION

In one aspect the present invention provides an improved electrical terminal for connecting electrical circuits. The electrical terminal includes a first means having an aperture of a predetermined size formed therein to permit engaging of the first means with a mating surface on an electrical device. It also includes an attachment means engageable with each of the first means and the electrical device for attaching the first means to a mating surface of the electrical device, and at least one anti-rotation locking means engageable with the first means at a predetermined location for preventing rotation of the first means when engaged with a mating surface of the electrical device. A second means is disposed adjacent one end of the first means for receiving at least one electrical wire therein in order to permit establishing electrical conductivity between the second means and such at least one electrical wire. Finally the present invention includes a third means disposed on an exterior surface of the second means for securing an insulating sleeve thereto along a periphery of the second means.

In another aspect the present invention provides in combination with a railway electrical coupler the improvement comprising an electrical terminal for connecting electrical circuits. The electrical terminal includes a first means having an aperture of a predetermined size formed therein to permit engaging of the first means with a mating surface on a railway electrical coupler. It also includes an attachment means engageable with each of the first means and the electrical device for attaching the first means to a mating surface of the railway electrical coupler, and at least one anti-rotation locking means engageable with the first means at a predetermined location for preventing rotation of the first means when engaged with a mating surface of the railway electrical coupler. A second means is disposed adjacent one end of the first means for receiving at least one electrical wire therein in order to permit establishing electrical conductivity between the second means and such at least one electrical wire. Finally the present invention includes a third means disposed on an exterior surface of the second means for securing an insulating sleeve thereto along a periphery of the second means.

### OBJECTS OF THE INVENTION

It is, therefore, a primary object of the present invention to provide a rotation proof ring terminal that provides an anti-rotation locking feature for an electrical ring terminal.

Another object of this invention is to provide a rotation proof ring terminal that permits establishing multiple connections to the mating electrical terminal while maintaining the rotation proof functionality.

Another object of this invention is to provide a rotation proof ring terminal that indexes single or multiple connections to the mating electrical terminal so that the associated wires flow in an orderly manner within the electrical coupler.

In addition to the above-described objects and advantages of the rotation proof ring terminal of this invention, various other objects and advantages of the present invention will become more readily apparent to those persons who are skilled in the same and related arts from the following more detailed description of the invention, particularly, when such description is taken in conjunction with the attached drawing figures and with the appended claims.

### DESCRIPTION OF THE DRAWING

FIG. 1 is an assembly view of an improved electrical terminal with mating electrical device according to a presently preferred embodiment of the invention.

FIG. 2 is an assembly view of a railway electrical coupler in combination with an electrical terminal according to a presently preferred embodiment of the invention.

### DETAILED DESCRIPTION OF THE PREFERRED EMBODIMENT

Prior to proceeding with the more detailed description of the present invention it should be noted that, for the sake of clarity, identical components, which have identical functions have been designated by identical reference numerals throughout the drawing Figures.

The present invention will now be described by way of a particular preferred embodiment, reference being had to the accompanying drawing wherein:

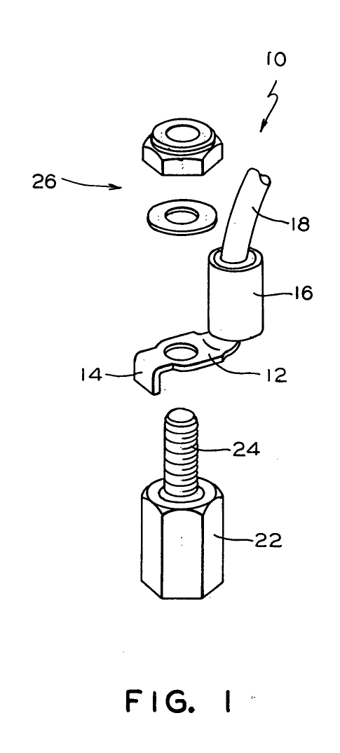

Reference is now made to FIG. 1 an improved electrical terminal for connecting electrical circuits is generally indicated by reference numeral 10. The improved electrical terminal 10, which is at least one of stamped or formed from a relatively thin conductive material, preferably stamped, is selected from a group consisting of tin, copper, aluminum, gold, nickel, silver, and platinum. The preferred thin conductive material is copper. Likewise, the thin conductive material may be a predetermined combination of materials selected from a group consisting of tin, copper, aluminum, gold, nickel, silver, and platinum.

The present invention further includes a first means 12 which encircles an aperture of a predetermined size formed therein to permit engaging the first means 12 with a mating surface of an electrical device 22.

It also includes an attachment means 26 engageable with each of the first means 12 and an electrical device 22 for attaching the first means 12 to a mating surface of the electrical device 22. The attachment means 26 further includes either internal or external (shown) threads for securing such electrical terminal to such mating surface of such electrical device 22. The internal thread utilizes a tapped opening for receiving a screw to secure the electrical terminal 10 to such a surface of the electrical device 22. Likewise, the external threads (as shown in FIG. 1) include a threaded post engageable with at least one of a washer, lock washer, and nut for securing the electrical terminal 10 to a mating surface of the electrical device 22.

The improvement of the present invention lies within the electrical terminal 10 having at least one anti-rotation locking means 14 engageable with the first means 12 at a predetermined location for preventing rotation of the first means 12 when engaged with a mating surface of the electrical device 22. Wherein at least one anti-rotation locking means 14 is a tab formed along a tangential edge of the first means 12. The tab formed along the tangential outer edge is bent in a predetermined direction with respect to the first means. The predetermined direction is about 90 degrees.

Additionally there is a second means disposed adjacent one end of the first means 12 for receiving at least one electrical wire 18 therein in order to permit establishing electrical conductivity between the second means and the electrical wire 18. The second means is either an open wire barrel or a closed wire barrel. The open wire barrel further includes a split substantially along an entire length of the open wire barrel for crimping the open wire barrel onto at least one such electrical wire 18 for establishing electrical contact. The closed wire barrel is soldered onto at least one such electrical wire 18 for establishing electrical conductivity.

Finally there is a third means disposed on an exterior surface of the second means for securing an insulating sleeve 16 thereto along a periphery of the second means. The insulating sleeve 16 is normally molded onto the second means.

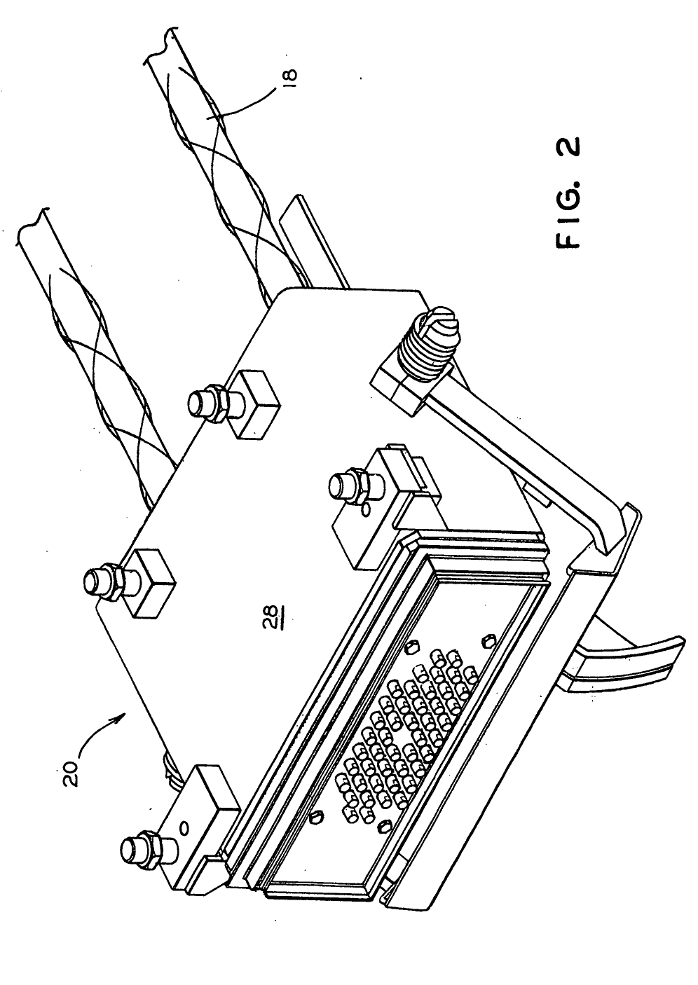

Reference is now made to FIG. 2 an assembly view of a railway electrical coupler in combination with an electrical terminal for connecting electrical circuits is generally indicated by reference numeral 20. The improvement comprises a first means having an aperture of a predetermined size formed therein to permit engaging the first means with a mating surface on such railway electrical coupler 28. An attachment means is engageable with each of the first means and such railway electrical coupler 28 for attaching the first means to such mating surface of such railway electrical coupler 28. There is at least one anti-rotation locking means engageable with the first means at a predetermined location for preventing rotation of the first means when engaged with such mating surface of such railway electrical coupler 28.

There is also a second means disposed adjacent one end of the first means for receiving at least one electrical wire 18 therein in order to permit establishing electrical conductivity between the second means and such electrical wire 18.

Finally there is a third means disposed on an exterior surface of the second means for securing an insulating sleeve thereto along a periphery of the second means.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

1. An improved electrical terminal for connecting electrical circuits, said electrical terminal comprising:
a) a first means having an aperture of a predetermined size formed therein to permit engaging said first means with a mating surface on an electrical device;
b) an attachment means engageable with each of said first means and such electrical device for attaching said first means to such mating surface of such electrical device;
c) at least one anti-rotation locking means engageable with said first means at a predetermined location for preventing rotation of said first means when engaged with such mating surface of such electrical device;
d) a second means disposed adjacent one end of said first means for receiving at least one electrical wire therein in order to permit establishing electrical conductivity between said second means and such electrical wire; and
e) a third means disposed on an exterior surface of said second means for securing an insulating sleeve thereto along a periphery of said second means.

2. An improved electrical terminal, according to claim 1, wherein said electrical terminal is at least one of stamped and formed from a relatively thin conductive material.

3. An improved electrical terminal, according to claim 2, wherein said electrical terminal is preferably stamped.

4. An improved electrical terminal, according to claim 2, wherein said relatively thin conductive material is selected from a group consisting of tin, copper, aluminum, gold, nickel, silver, and platinum.

5. An improved electrical terminal, according to claim 4, wherein said relatively thin conductive material is preferably copper.

6. An improved electrical terminal, according to claim 4, wherein said relatively thin conductive material is a predetermined combination of material selected from a group consisting of tin, copper, aluminum, gold, nickel, silver, and platinum.

7. An improved electrical terminal, according to claim 1, wherein said at least one anti-rotation locking means is a tab formed along a tangential edge of said first means.

8. An improved electrical terminal, according to claim 7, wherein said tab formed along said tangential outer edge is bent in a predetermined direction with respect to said first means.

9. An improved electrical terminal, according to claim 8, wherein said predetermined direction is about 90 degrees.

10. An improved electrical terminal, according to claim 1, wherein said insulating sleeve is molded onto said second means.

11. An improved electrical terminal, according to claim 1, wherein said first means encircles said aperture of a predetermined size.

12. An improved electrical terminal, according to claim 1, wherein said second means is at least one of an open wire barrel and a closed wire barrel.

13. An improved electrical terminal, according to claim 12, wherein said open wire barrel further includes a split substantially along an entire length of said open wire barrel for crimping said open wire barrel onto at least one such electrical wire for establishing said electrical contact.

14. An improved electrical terminal, according to claim 12, wherein said closed wire barrel is soldered onto at least one such electrical wire for establishing said electrical conductivity.

15. An improved electrical terminal, according to claim 1, wherein said attachment means further includes threads for securing said electrical terminal to such mating surface of such electrical device.

16. An improved electrical terminal, according to claim 15, wherein said threads are at one of internal and external to such electrical device.

17. An improved electrical terminal, according to claim 16, wherein such internal threads include a tapped opening for receiving a screw to secure said electrical terminal to such mating surface of such electrical device.

18. An improved electrical terminal, according to claim 16, wherein such external threads include a threaded post engageable with at least one of a washer, lock washer, and nut for securing said electrical terminal to such mating surface of such electrical device.

19. In combination with a railway electrical coupler the improvement comprising an electrical terminal for connecting electrical circuits, said electrical terminal including:
a) a first means having an aperture of a predetermined size formed therein to permit engaging said first means with a mating surface on such railway electrical coupler;
b) an attachment means engageable with each of said first means and such railway electrical coupler for attaching said first means to such mating surface of such railway electrical coupler;
c) at least one anti-rotation locking means engageable with said first means at a predetermined location for preventing rotation of said first means when engaged with such mating surface of such railway electrical coupler;
d) a second means disposed adjacent one end of said first means for receiving at least one electrical wire therein in order to permit establishing electrical conductivity between said second means and such electrical wire; and
e) a third means disposed on an exterior surface of said second means for securing an insulating sleeve thereto along a periphery of said second means.
